(19) United States
(12) Patent Application Publication
(10) Pub. No.: US 2021/0381419 A1
(43) Pub. Date: Dec. 9, 2021

(54) SYSTEM AND METHOD FOR FACILITATING REGENERATION OF PARTICULATE FILTERS IN A FLEET OF VEHICLES

(71) Applicant: Zonar Systems, Inc., Seattle, WA (US)

(72) Inventors: Michael Charles KING, Kent, WA (US); Greg COLVIN, Maple Valley, WA (US)

(21) Appl. No.: 17/287,036

(22) PCT Filed: Oct. 15, 2019
(86) PCT No.: PCT/US2019/056244

§ 371 Date: Apr. 20, 2021

Related U.S. Application Data
(60) Provisional application No. 62/749,500, filed on Oct. 23, 2018.

(51) Int. Cl. F01N 9/00; G07C 5/00

(52) U.S. Cl. CPC F01N 9/002; F01N 2900/0601; F01N 2900/16; G07C 5/008

(57) ABSTRACT

A system and method that forwards information concerning the condition of the particulate filter (14) in each fleet vehicle to a remote station (56). This information is sorted (114) and displayed (62) to a human operator, who then makes a decision regarding particulate filter maintenance, on a fleet wide basis (116). The human operator may select a set of vehicles to undergo filter regeneration during a particular time slot, at a facility with a limited capacity to perform filter regeneration during any particular time slot. Typically, this will be overnight, for example for a metropolitan bus service that is busy during the day but has greatly reduced or nonexistent service at nighttime.

### BACKGROUND OF THE INVENTION

### 1. Field of the Invention

The present invention is in the field of fleet management.

### 2. Background Art

Those tasked with managing a fleet of diesel-powered vehicles may be challenged by the need to regenerate the particulate filters which diesel-powered vehicles are required to have. Fleets of trucks, buses, parcel delivery vans, fuel delivery trucks and emergency vehicles, such as firetrucks, may all include or be composed mostly of diesel vehicles. Regeneration is a process wherein the particulates that have collected in the filter are heated to a temperature at which they burn off. A truck travelling a long distance on a highway may maintain a speed and resultant engine temperature sufficient to create these high temperatures in the exhaust, permitting regeneration to take place on lengthy driving segments. But a fleet of diesel powered urban delivery (parcel delivery, for example), collection (trash collection, for example) vehicles, or urban-route buses does not have this advantage, and “parked regeneration” must be relied upon, wherein the vehicle is parked, and a burner specifically designed to burn off the particulate matter that has accumulated in the filter is used for regeneration.

The decision to initiate regeneration has been generally left to the individual driver, based on warnings generated by, referring to FIG. 1, an onboard system 10, that includes a backpressure sensor 12, which includes a pressure sensor 12a, located before (upstream—in the flow of exhaust) the diesel particulate filter (DPF) 14, a downstream and pressure sensor 12b and a computation unit 12c that computes the pressure difference and provides a figure representative of backpressure, caused by exhaust gas being forced through the DPF 14, to an onboard CPU 18 (which may be an engine control unit [ECU]). The onboard CPU 18 thresholds this figure, and provides a first warning (for example, a yellow light) on a dashboard display 20, when the backpressure exceeds a first threshold and a second, more urgent warning (for example a flashing red light) when the backpressure exceeds a higher threshold, indicating that the engine may shut off soon, due to backpressure reaching a level that prevents the engine from functioning. This type of dashboard display gives the driver/operator only a general notion of the need to perform regeneration, and still leaves a fair degree of uncertainty.

For city buses, the need to maintain a tight schedule, together with the urban environment of the bus routes, where the high temperatures created by regeneration might endanger nearby persons, leads to the practice of performing regeneration on a chosen set of vehicles, overnight at the bus yard, which can typically process a limited number of vehicles per night. Gathering information to help in this selection process is typically cumbersome, with the need to collect information regarding which vehicles have dashboard regeneration lights on. Moreover, the information presented by the dashboard lights is lacking in detail, typically having just three levels of “no indication,” “regeneration needed” and “regeneration urgently needed.” This can lead to unfortunate inefficiencies, where a first vehicle is selected for overnight regeneration, when a second vehicle would have been a better choice for regeneration.

Other urban-route vehicles, such as trash collectors, parcel delivery and fuel delivery generally do not have the same need to maintain a tight schedule and may interrupt their route to perform a parked regeneration. But there may be problems associated with doing so. For example, the heat of regeneration may pose a danger at a busy cargo terminal, where items are being loaded and unloaded about the vehicle undergoing regeneration. Also, regeneration must be avoided at fueling stations, where the heat of regeneration could ignite fuel. Also, a busy downtown area might present a challenge for a driver faced with a regeneration warning light. To avoid these issues, however, some regeneration may be performed at a vehicle yard, typically overnight when the fleet is less busy.

Referring to FIG. 2, in systems available today, it is possible for a user to define, by way of “geo-fencing” on a map, an area where a driver may not perform regeneration. FIG. 2 shows a screen 30, that may be shown on remote station display, that facilitates the creation of geo-fenced zones. A left-most panel 32 permits a user to establish driver behavior that is discouraged or encouraged, with a box 34 that permits a message to drivers to be shown when a driver enters a geofenced zone. The middle panel 36 permits a user to forbid vehicle behavior, for example regeneration in a zone. A map 38 permits a user to create a geo-fenced area 40. In one system, a driver entering such a defined area, is given a warning to not perform regeneration. In another embodiment, the regeneration system is disabled. A costly engine shutdown, forcing towing and repair may occur, if a driver enters a geo-fenced zone, where DPF regeneration is disabled, at a time when his filter is full and the backpressure is so great it may cause the engine to shut down.

In normal operation, a DPF gradually fills with soot, which is then burned off during regeneration. But under some conditions, for example, when oil is being burned by the engine, ash can build up. Ash does not burn off during regeneration and can degrade DPF operation.

### SUMMARY OF INVENTION

These issues are addressed by a system and method that forwards information concerning the condition of the particulate filter in each vehicle to a remote station. This information may be sorted and displayed to a human operator, who then makes a decision regarding particulate filter maintenance, on a fleet wide basis. For example, the human operator may select a set of vehicles to undergo filter regeneration during a particular time slot, at a facility with a limited capacity to perform filter regeneration during any particular time slot. Typically, this will be overnight, for example for a metropolitan bus service that is busy during the day but has greatly reduced or nonexistent service at night-time. Also, the computer system at a remote station may select the vehicles to undergo regeneration. A human operator, or the remote station computer system may assign vehicles that are approaching a backpressure that might result in a need for a parked regeneration, to routes that do not include geofenced areas forbidding regeneration, or that might otherwise present a challenge in performing a parked regeneration.

In another aspect, the remote station computer system also receives telematics data for each fleet vehicle, describing the engine “on” time and the types of driving and other engine use undertaken by the vehicle. In some instances, exhaust temperature is included in the telematics data. The remote station includes a computer program that models the growth in particulate deposits in the particulate filters and the effect this will have on DPF backpressure. This predicted backpressure is compared with the actual backpressure reported by the telematics unit of each vehicle, to determine if the increase in backpressure over time is significantly greater than what is predicted. If it is, this can be an indication of an engine problem, or a problem with the particulate filter and a alert is issued, indicating that an inspection should be performed to determine if the root of the problem can be found.

In a further aspect a display in the cab is used to provide more specific information regarding the status of the DPF than has been heretofore available to the driver. An estimated engine on time until the need to perform regeneration is critical is displayed. Alternatively, a projected route is displayed and the location where regeneration is projected to become critical is shown.

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

In addition to the exemplary aspects and embodiments described above, further aspects and embodiments will become apparent by reference to the drawings and by study of the following detailed descriptions.

### BRIEF DESCRIPTION OF DRAWINGS

Various embodiments of the invention are disclosed in the following detailed description and accompanying drawings.

FIG. 1 is an illustration of a prior art system for monitoring and reporting data from a diesel particulate filter.

FIG. 2 is a depiction of a prior art screen display of a geofenced area.

FIG. 3 is a block diagram of a system for monitoring and reporting data from a vehicle equipped with a particulate filter, to a remote station.

FIG. 4 is a flow chart of a process for scheduling particulate filter regeneration in a fleet of diesel vehicles equipped with particulate filters.

FIG. 5 is a flow chart of a process of using particulate filter backpressure data from a fleet of vehicles, to improve fleet operations.

FIG. 6 is a schematic illustration of a vehicle that includes a GPS unit.

FIG. 7 is a block diagram representation of a fleet vehicle telematics unit that may be used in the methods described herein.

FIG. 8 is a block diagram of a tablet computer for a fleet vehicle, that may be used in the methods described herein.

FIG. 9 is an illustration of a display showing a map, indicating current vehicle location along a projected route, and the location where the need to regenerate the DPF will become critical.

### BEST MODES OF CARRYING OUT THE INVENTION

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

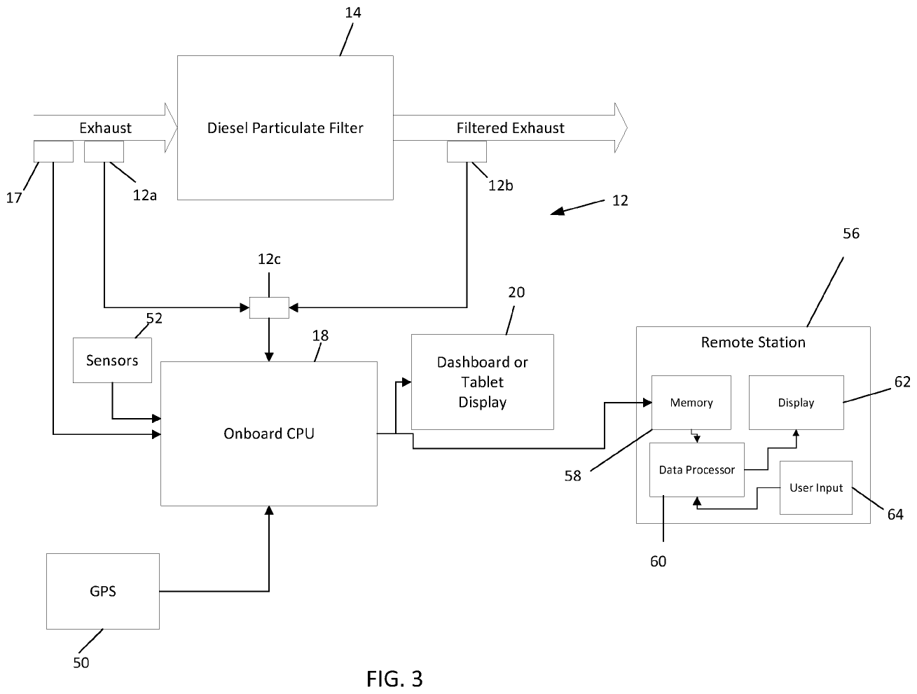

Referring to FIG. 3, a preferred embodiment of a system and method for facilitating the management of diesel fleet vehicle particulate filter regeneration 10, each fleet vehicle 11 utilizes a backpressure sensor 12, typically comprising a first gas pressure sensor 12a placed in the exhaust stream before the particulate filter 14, and a second gas pressure sensor 12b, placed in the filtered exhaust stream. The pressure difference between sensors 12a and 12b is the backpressure. If the backpressure reaches an extreme it will cause the engine to shut off.

Some vehicles may also include an exhaust gas temperature sensor 17, placed in front of filter 14. In a preferred embodiment, information from sensors 12 and temperature sensor 17 is sent to an onboard CPU 18, which also receives data from a global positioning system (GPS) 50, and a suite of other sensors 52, which forwards selected data to a transmitter 54, which, in turn sends the data from CPU 18, to a remote station 56. The selected data includes the GPS device, so that vehicle location and speed is repeatedly sent to remote station 56. Remote station 56 includes a memory 58, a data processer 60, a display 62 and a user input device 64.

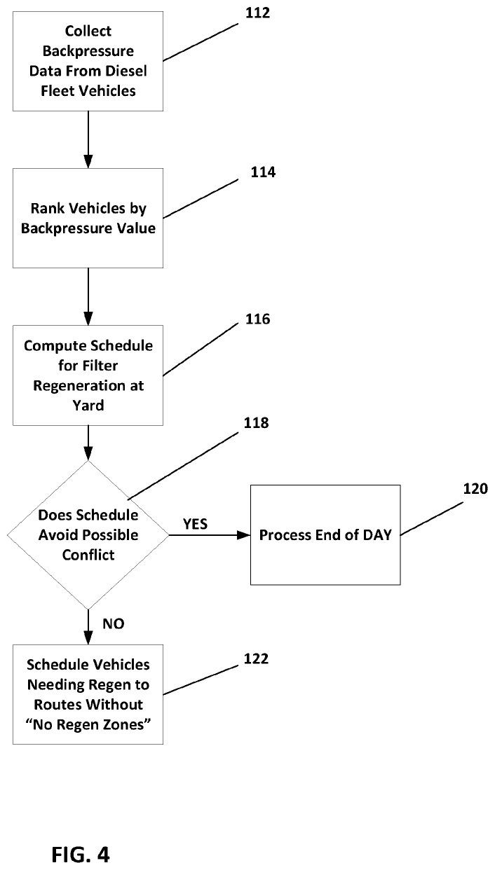

Referring to FIG. 4, in a first preferred method 110 of managing fleet regeneration, readings from the backpressure sensor 12 of each fleet vehicle 11 sent by transmitters 54 are received and entered into memory 58 of remote station 56 (block 112). There an operator may use user input 64 to command a display of these values sorted by pressure level (block 114). The operator then picks a first group of vehicles with the highest backpressure levels to be regenerated, in the next available regeneration time slot, typically overnight (block 116). In an alternative preferred embodiment, block 116 is performed automatically by data processor 60. Then either the human operator or the data processor 60 checks the vehicles with the next highest values of backpressure (decision box 118). If none are in jeopardy of requiring regeneration before an opportunity for regeneration in the yard, then the process is over for the day, or other time period (block 120). If there are vehicles that may require regeneration prior to the first opportune moment for performing this task, these vehicles are assigned to routes that do not have “no regen” zones or that have some highway driving that might cause some natural regeneration (block 122). For some types of fleets, little to no regeneration will be performed in a vehicle maintenance yard, and for these types of fleets (typically truck fleets), block 116 is not performed, but block 122 is very important. In an alternative preferred embodiment, this process is automated, with the remote station data processor 60 displaying a set of vehicles to be regenerated in the next time slot and displaying this information or emailing it, or otherwise sending it, to a crew of workers who perform the actual regeneration. The computer may also display or send vehicle route assignments based on an effort to avoid sending vehicles that might require regeneration into a “no regen” zone or to assign vehicles with high backpressure readings to routes where at least some regeneration naturally occurs. For example, vehicles that are within a specified percentage of the filter load that trips the first warning light for required regeneration may be assigned only to routes that do not include no-regen zones. In one preferred embodiment this specified percentage is 10%.

Personnel then act on these computer-generated mandates for vehicles to undergo regeneration and for route assignments. In a further embodiment, the computer assembly directly controls the vehicles, by means of RF data links, or other data links, and causes them to undergo regeneration.

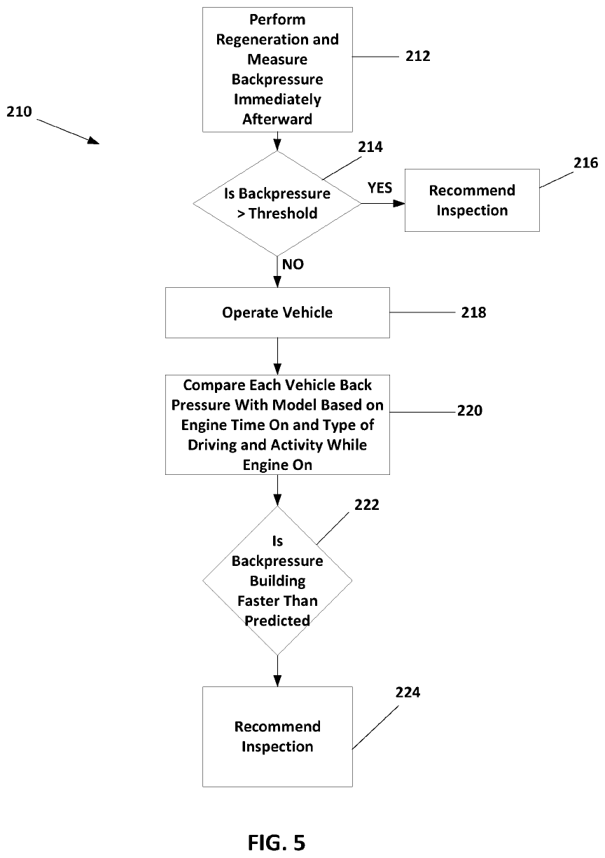

Referring to FIG. 5, in an additional aspect 210, regeneration events are noted, at least by the sudden drop in backpressure, and the level of backpressure is noted immediately after regeneration (block 212). This value is compared with a threshold that represents the typical level of backpressure immediately after a regeneration, plus a margin (decision box 214). If the level of backpressure is higher than the threshold, an inspection is recommended (block 216). Alternatively, the person performing the regeneration may be asked to perform a secondary regeneration, as the high reading may be an indication that the regeneration was not performed entirely correctly. A high level of backpressure immediately following regeneration (or the second regeneration) may indicate that there is a problem with the particulate filter, which may have been fouled by a substance that does not burn off during regeneration, such as lubricant residue. This may indicate an engine problem, which if caught early can save operating costs. If backpressure is under the threshold, normal operations may resume (block 218). Then, as the vehicle is operated, the increase in backpressure over time is compared to a predicted backpressure, based on modeling using the accumulated engine “on time,” speed driven and other aspects of driving conditions since the last regeneration (block 220). If the backpressure increases substantially more rapidly than the model predicts, for the amount and type of engine use that has occurred (decision box 222), then an indication is given that an inspection may be warranted to determine the source of the overly fast apparent increase in back pressure (block 224). Engine problems, for example, causing oil to be burned by the engine, may be occurring. On the other hand, the backpressure gauge may be degraded and providing incorrect information.

Exemplary GPS Device with Onboard Computing Environment

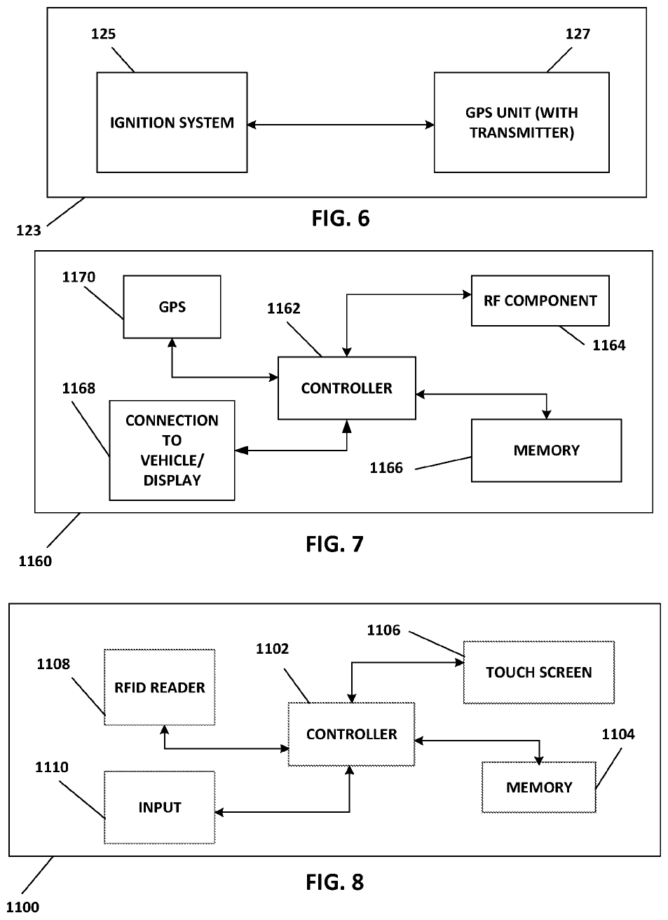

FIG. 6 schematically illustrates a vehicle 123 that includes a GPS unit 127 configured to collect GPS data that can be used to determine if an enrolled vehicle is approaching a location for which a remote user has established zone-based driver/vehicle definitions. In some embodiments a remote monitoring service analyzes the GPS data received from enrolled vehicles to determine if a vehicle is approaching such a zone/location, whereas in other embodiments, the locations or zone-based definition are sent from the remote server to the enrolled vehicle, and a processor in the vehicle makes a determination of whether any zone-based behavior definition applies. In some embodiments, a list of locations is stored at the vehicle, and when the vehicle approaches a noted location the processor in the vehicle calls the remote server to obtain the zone based behavior definitions that apply to that location (the list of locations will consume fewer memory resources). Vehicle 123, such as a bus or a truck includes GPS unit 127 coupled with an ignition system 125 of the vehicle. In an exemplary embodiment, the GPS unit 127 will be coupled with the ignition switch, such that it is assumed that when the ignition switch is on, the engine of the vehicle is actually running, and the GPS unit 127 will be activated. As described in greater detail below, GPS data can be used for a plurality of metrics, including idle time, deceleration time and magnitude, acceleration time and magnitude, and to determine if a driver has violated a speed limit. The most basic GPS unit is able to determine a position of the vehicle at a specific time. That positional information can be used to calculate the speed of a vehicle by determining the change in position of the vehicle between two successive points in time, and to calculate the acceleration or deceleration of the vehicle by determining the change in speed of the vehicle over a time increment. More typically, GPS units automatically determine position, speed, and acceleration/deceleration internally, and these metrics would then not need to be determined by an external computing device (remote or local).

GPS unit 127 preferably includes or is connected to a wireless transmitter (not separately shown), such that the GPS data can be wirelessly transmitted to a remote computing device, preferably in real-time. The remote computing device can be programmed to monitor vehicle location and zone-based behavior definitions, such that when a vehicle approaches such a zone, the corresponding zone-based behavior definition is conveyed to the vehicle (preferably with sufficient advance timing so that the zone-based behavior definition is available at the vehicle when the vehicle arrives at the defined location). It should be recognized that as an alternative, GPS unit 127 can include an onboard memory, such that either the zone-based behavior definitions (or at least the locations/zones) are stored in the GPS unit, and the GPS unit monitors the location of the vehicle to determine if any zone-based behavior should apply. It should be understood that the concepts disclosed herein encompasses coupling such a GPS unit to vehicle sensors and/or a vehicle data bus, such that driver behavior can be monitored, to determine if the driver has complied with any zone-based driver behavior definitions presented to the driver at a particular location. While not specifically shown in FIG. 6, it should be understood that GPS unit 127 can include a processor that uses GPS data to determine if any zone-based behaviors apply to the current vehicle location.

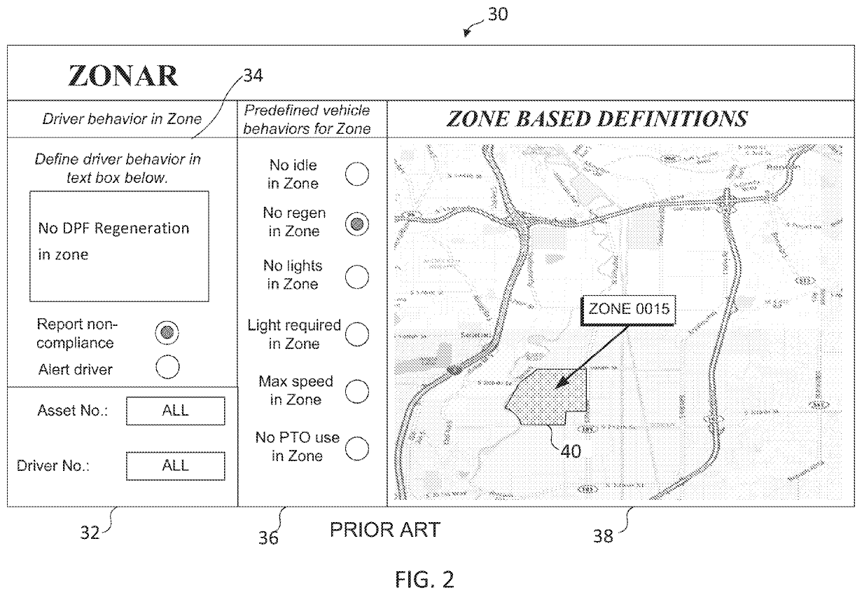

FIG. 7 is a functional block diagram of an exemplary telematics device added to an enrolled vehicle to implement one or more of the methods of disclosed herein. An exemplary telematics unit 1160 includes a controller 1162, a wireless data link component 1164, a memory 1166 in which data and machine instructions used by controller 1162 are stored (again, it will be understood that a hardware rather than software based controller can be implemented, if desired), a position sensing component 1170 (such as a GPS receiver), and a data connection component 1168 (noting that in some embodiments a plurality of data connect ions are provided). Exemplary data connections include physical data links, as well as wireless data links such as Wi-Fi, IR, and Bluetooth™. Data connection component 1168 enables zone-based driver behavior definitions (or rules) to be conveyed to a display device to present to a user when the vehicle arrives at or approaches a location for which a remote user has defined a zone-based driver behavior. Data connection component 1168 also enables zone-based vehicle behavior definitions (or programming instructions) to be conveyed to vehicle controller responsible for controlling a particle vehicle system (such as lights, diesel particulate filter regeneration, engine idling, and other behaviors generally as noted in portion 107 of FIG. 2, noting that such vehicle behaviors are simply exemplary, and are not intended to be limiting) when the vehicle arrives at or approaches a location for which a remote user has defined a zone based vehicle behavior.

The capabilities of telematics unit 1160 are particularly useful to fleet operators. Telematics unit 1160 is configured to collect position data from the vehicle (to enable vehicle owners to track the current location of their vehicles, and where they have been) and to collect vehicle operational data (including but not limited to engine temperature, coolant temperature, engine speed, vehicle speed, brake use, idle time, and fault codes), and to use the RF component 1164 to wirelessly convey such data to vehicle owners. These data transmissions can occur at regular intervals, in response to a request for data, or in real-time, or be initiated based on parameters related to the vehicle's speed and/or change in location. The term “real-time” as used herein is not intended to imply the data are transmitted instantaneously, since the data may instead be collected over a relatively short period of time (e.g., over a period of seconds or minutes), and transmitted to the remote computing device on an ongoing or intermittent basis, as opposed to storing the data at the vehicle for an extended period of time (hour or days), and transmitting an extended data set to the remote computing device after the data set has been collected. Data collected by telematics unit 1160 can be conveyed to the vehicle owner using RF component 1164. If desired, additional memory can be included to temporarily store data if the RF component cannot transfer data, and/or to store locations corresponding to defined zones (i.e., zones where specific vehicle or driver behaviors have been defined), or the specific zone based behavior definitions themselves (noting that storing the zones only will reduce memory demand, but will require a call to a remote server to obtain the specific zone based behavior definitions when the vehicle approaches a defined zone). In particularly preferred embodiments, the RF components is GSM or cellular technology based.

In at least one embodiment, the controller 1162 is configured to implement some of the steps of FIGS. 4 and 5. It should be understood that any of the vehicle-based steps of FIGS. 4 and 5 could be distributed to one or more other processers/controllers at the vehicle.

### Exemplary Tablet for In Vehicle Use to Present Zone Based Driver Behaviors to Driver

FIG. 8 is a functional block diagram of an exemplary mobile computing device 1100 for fleet telematics including a display 1106 and a controller 1102 configured to present at least one telematics application to a user, and to present a zone-based driver behavior to a driver in accord with the concepts disclosed herein. A non-transitory physical memory 1104 is included, upon which machine instructions define one or more applications are stored. Note that in embodiments including device 1100 the zone-based behavior definitions can be stored in memory 1104, or locations corresponding to zones for which behaviors have been defined. Device 1100 includes an optional RFID reader 1108 (or other sensor) that enables drivers to log into the tablet, so that non-compliant behavior (in response to zone-based driver behavior rules imposed at a selected zone) can be tracked to a specific driver. In exemplary but not limiting embodiments, the device includes at least one data input 1110 that can be used to logically couple the device to a vehicle data bus or some other device (such as telematics device 1160 of FIG. 7). Note that in embodiments where the current location of the vehicle is monitored to determine if the vehicle is approaching a location for which a zone based behavior has been defined, controller 1102 can implement that function so long as the controller has access to the vehicle location data (from the exemplary devices of FIG. 6 or 7) and to the defined zone locations.

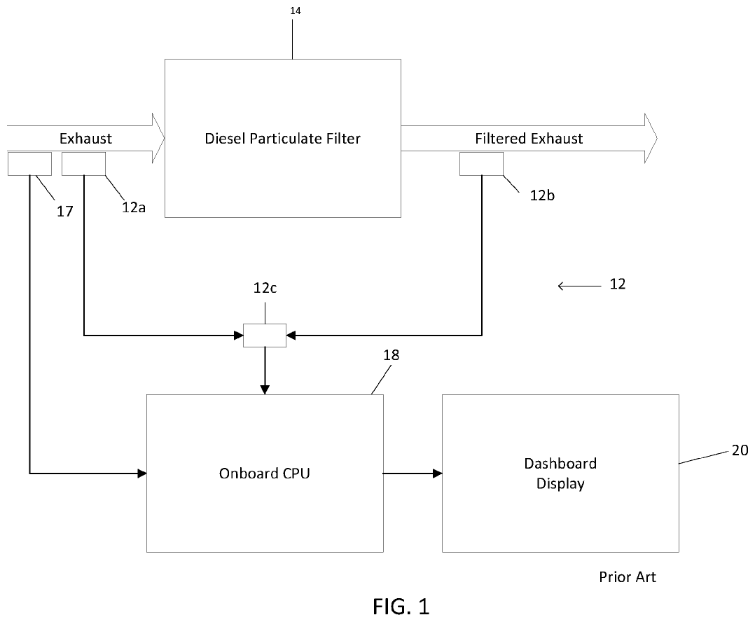

Device 1100 may include additional components, including but not limiting to a GSM component, a Wi-Fi component, a USB component, a rechargeable battery, and in at least one embodiment a GPS component (in which case the GPS devices of FIGS. 6 and 7 are not required). Significantly, the display (or speakers) of device 1100 can be used to provide the zone-based driver behavior rules in addition to, or instead of the display. Controller 1102 can be employed in some embodiments to implement one of more of the vehicle side steps of FIGS. 1 and 2.

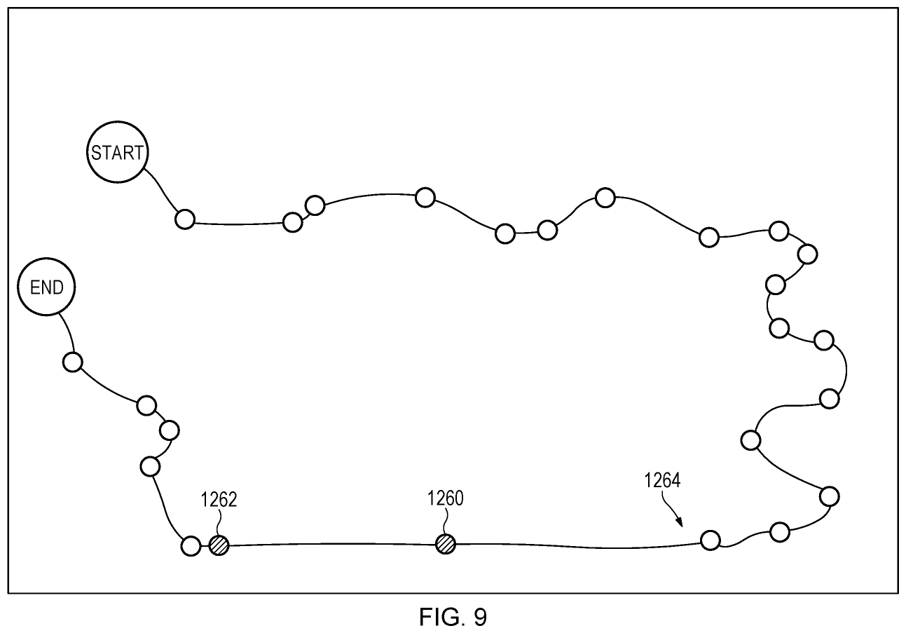

In a further embodiment, each fleet vehicle 11 is equipped with a screen display, having a rectangular field of pixels. In some embodiments, this display is present in a tablet computer, that is present in the cab of the vehicles. Such a display, or even a more primitive display, may be used to display more detailed information to the driver concerning the state of the DPF, than is available from the dashboard lights. In one embodiment, an estimate of the number of hours that can be driven (that is, during which the engine can be on) before the need to regenerate will become critical (that is, it threatens the ability to continue operating the vehicle), is calculated by onboard CPU 18 shown on the display 20. In an alternative embodiment, the calculation is performed by data processor 60 and sent back to onboard CPU 18, for display on display 20. In this embodiment the CPU 18, may be the CPU of the tablet having display 20. A cut-off backpressure is typically set by the manufacturer, and may be for a truck engine, on the order 10 kilopascals (KPa). As noted above, an estimate of the number of hours that can be driven before the need to regenerate will become critical will be made, and this estimate may be based on an estimate of the engine “on” time until that back pressure is likely to be reached. This estimate can be based on the back pressure reading, and can be frequently updated, for example once per minute. The estimate may be formed by examining the history of vehicles of the same type, and reviewing how back pressure changed over time, starting with the same back pressure reading. Additionally, the driver may be informed of a nearby location, where a parked regeneration can be performed, and be given directions to this location. Referring to FIG. 9, in an additional embodiment, the onboard display is used to show a map of the current projected vehicle route 1264 and the location 1262 where regeneration is expected become critical is shown on that map, together with the current vehicle location 1260. This estimate is based on the type of miles upcoming on the route (uphill, stop and go, downhill, etc.) and the experience gained from tracking the backpressure of similar vehicles, being driven in similar conditions, and the maximum allowable backpressure.

In recapitulation, embodiments may include: a system for managing a fleet of diesel vehicles, wherein each vehicle is equipped with a particulate filter that requires regeneration, to avoid problems associated with the need to perform regeneration and having: a back-pressure sensor, in each vehicle, providing back-pressure readings for the particulate filter. A telematics unit, in each vehicle, receives the back-pressure readings and sends the information representative of these readings on to a remote station. The remote station has receiving equipment, a data processing assembly and a display, collectively adapted to receive the information representative of the back-pressure readings from the telematics units of the vehicles, and to display information representative of the back-pressure readings to remote station personnel. the aspects of fleet operation are the choice of a set of vehicles upon which to perform filter regeneration during a time interval. In an embodiment of this system the data processing assembly computes, and the display shows guidance, regarding aspects of fleet operation based on the back-pressure readings from the vehicles. The aspects of fleet vehicle operations may the choice of a set of vehicles upon which to perform filter regeneration during a time interval, which may be the nighttime period immediately following the determination. In an embodiment, the data processing assembly ranks the vehicles in order of need for regeneration and can show this ranking on the display, when commanded to by an operator. In another embodiment, the system includes computer readable memory storing information defining regions wherein regeneration is undesirable therein, and wherein the aspects of fleet operation include vehicle route assignments, to avoid assigning a vehicle approaching a need for regeneration to a route including an area where regeneration is undesirable. In yet a further embodiment, the sensors include gas pressure sensors in the exhaust stream before and after the particulate filter of each vehicle, and wherein readings from the gas pressure sensors are used to determine, for each vehicle, particulate filter conditions. In a variant of this embodiment, the remote station receives real time updates on vehicle operations for each vehicle, including mileage driven and wherein the data processing assembly uses this real time information to form an estimate of filter conditions, and compares this estimate to readings from the gas pressure sensors to detect vehicle mechanical problems. In a variant of this variant, an estimate of filter condition formed from vehicle operations being greater than a threshold difference from an estimate of filter condition formed from contemporaneous gas pressure readings, is indicative of one or more out of a group of problems consisting essentially of: gas pressure sensor inaccuracy; the engine burning oil; and a compromised particulate filter.

In another embodiment, a method for managing a fleet of diesel vehicles, wherein each vehicle is equipped with a particulate filter that requires regeneration, to avoid problems associated with the need to perform regeneration. In each vehicle, information indicative of particulate filter condition is sensed, and this information is sent to a remote station. The information at the remote station is analyzed to determine aspects of fleet operation management and these aspects are implemented in fleet operation management. In an embodiment the aspects of fleet operation include the choice of a set of vehicles upon which to perform filter regeneration during a time interval. In a variant of this embodiment, the time interval is during the nighttime period immediately following the determination. In another embodiment, the remote station ranks the vehicles in order of need for regeneration. In another variant of this embodiment, the remote station includes computer readable memory storing information defining regions wherein regeneration is undesirable, and wherein the aspects of fleet operation include vehicle route assignments, to avoid a requirement for regeneration in an area where regeneration is undesirable. In another variant, sensing information indicative of particulate filter condition includes forming readings of gas pressure in the exhaust stream before and after the particulate filter of each vehicle, and wherein these readings of gas pressure are used to determine, for each vehicle, particulate filter conditions. In a variant of this variant, the remote station receives real time updates on vehicle operations for each vehicle, including mileage driven and wherein the computer analysis uses this real time information to form an estimate of filter conditions, and compares this estimate to the readings of exhaust back pressure, to detect vehicle mechanical problems. In a variant of this variant, an estimate of filter condition formed from vehicle operations being greater than a threshold difference from an estimate of filter condition formed from contemporaneous gas pressure readings, is indicative of one or more out of a group of problems consisting essentially of: gas pressure sensor inaccuracy; an engine problem causing noncarbon substances to be present in the exhaust; and a compromised particulate filter.

In another embodiment, the invention may take the form of a vehicle system, comprising: a diesel engine; an exhaust system in fluid communication with the diesel engine and including: (i) a diesel particulate filter; and a backpressure sensor. The vehicle system also includes a cab; a computer, in communication with said backpressure sensor; and a display situated in the cab, in communication with the computer. Further, the computer causes said display to show an indication of the urgency of the need to perform a regeneration of the diesel particulate filter.

In a variant of this embodiment, the computer is an onboard computer. In an alternative variant, the computer is a computer at a remote station. In yet another variant, the indication of the urgency of the need to perform a regeneration is an estimate of engine on time, before the need to regenerate becomes critical. In yet another variant, the indication of the urgency of the need to perform a regeneration is a location along a projected route, indicating an estimate of where the need to perform a regeneration will become critical.

### INDUSTRIAL APPLICABILITY

The present invention finds industrial applicability in the operation of a fleet of diesel-powered vehicles. And in the production and provision of equipment to facilitate the operation of a fleet of diesel-powered vehicles.

While a number of exemplary aspects and embodiments have been discussed above, those possessed of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A system for managing a fleet of diesel vehicles, wherein each vehicle is equipped with a particulate filter that requires regeneration, to avoid problems associated with the need to perform regeneration and comprising:
(a) a back-pressure sensor, in each vehicle, providing back-pressure readings for the particulate filter;
(b) a telematics unit, in each vehicle, that receives the back-pressure readings and sends the information representative of these readings on to a remote station;
(c) receiving equipment, a data processing assembly and a display in the remote station, collectively adapted to receive the information representative of the back-pressure readings from the telematics units of the vehicles, and to display information representative of the back-pressure readings to remote station personnel.

2. The system of claim 1, wherein the data processing assembly computes, and the display shows guidance, regarding aspects of fleet operation based on the back-pressure readings from the vehicles.

3. The system of claim 2, wherein the aspects of fleet operations are the choice of a set of vehicles upon which to perform filter regeneration during a time interval.

4. The system of claim 3, wherein the time interval is during the nighttime period immediately following the determination.

5. The system of claim 1, wherein the data processing assembly ranks the vehicles in order of need for regeneration and can show this ranking on the display, when commanded to by an operator.

6. The system of claim 1, wherein the system includes computer readable memory storing information defining regions wherein regeneration is undesirable therein, and wherein the aspects of fleet operation include vehicle route assignments, to avoid assigning a vehicle approaching a need for regeneration to a route including an area where regeneration is undesirable.

7. The system of claim 1, wherein the sensors include gas pressure sensors in the exhaust stream before and after the particulate filter of each vehicle, and wherein readings from the gas pressure sensors are used to determine, for each vehicle, particulate filter conditions.

8. The system of claim 7, wherein said remote station receives real time updates on vehicle operations for each vehicle, including mileage driven and wherein the data processing assembly uses this real time information to form an estimate of filter conditions and compares this estimate to readings from the gas pressure sensors to detect vehicle mechanical problems.

9. The system of claim 8, wherein an estimate of filter condition formed from vehicle operations being greater than a threshold difference from an estimate of filter condition formed from contemporaneous gas pressure readings, is indicative of one or more out of a group of problems consisting essentially of:
(a) gas pressure sensor inaccuracy;
(b) the engine burning oil; and
(c) a compromised particulate filter.

10. A method for managing a fleet of diesel vehicles, wherein each vehicle is equipped with a particulate filter that requires regeneration, to avoid problems associated with the need to perform regeneration:
(a) in each vehicle, sensing information indicative of particulate filter condition and sending this information to a remote station;
(b) analyzing the information at the remote station to determine aspects of fleet operation management; and
(c) implementing the aspects of fleet operation management.

11. The method of claim 10, wherein the aspects of fleet operation include the choice of a set of vehicles upon which to perform filter regeneration during a time interval.

12. The method of claim 11, wherein the time interval is during the nighttime period immediately following the determination.

13. The method of claim 10, wherein the remote station ranks the vehicles in order of need for regeneration.

14. The method of claim 10, further wherein the remote station includes computer readable memory storing information defining regions wherein regeneration is undesirable, and wherein the aspects of fleet operation include vehicle route assignments, to avoid a requirement for regeneration in an area where regeneration is undesirable.

15. The method of claim 10, wherein sensing information indicative of particulate filter condition includes forming readings of gas pressure in the exhaust stream before and after the particulate filter of each vehicle, and wherein these readings of gas pressure are used to determine, for each vehicle, particulate filter conditions.

16. The method of claim 15, wherein the remote station receives real time updates on vehicle operations for each vehicle, including mileage driven and wherein the computer analysis uses this real time information to form an estimate of filter conditions, and compares this estimate to the readings of exhaust back pressure, to detect vehicle mechanical problems.

17. The method of claim 15, wherein an estimate of filter condition formed from vehicle operations being greater than a threshold difference from an estimate of filter condition formed from contemporaneous gas pressure readings, is indicative of one or more out of a group of problems consisting essentially of:
(a) gas pressure sensor inaccuracy;
(b) an engine problem causing noncarbon substances to be present in the exhaust; and
(c) a compromised particulate filter.

18. A vehicle system, comprising:
(a) a diesel engine;
(b) an exhaust system in fluid communication with the diesel engine and including:
(i) a diesel particulate filter;
(ii) a backpressure sensor;
(c) a cab;
(d) a computer, in communication with said backpressure sensor;
(e) a display situated in the cab, in communication with the computer; and
(f) wherein said computer causes said display to show an indication of the urgency of the need to perform a regeneration of the diesel particulate filter.

19. The system of claim 18, wherein the computer is an onboard computer.

20. The system of claim 18, wherein the computer is a computer at a remote station.

21. The system of claim 18, wherein the indication of the urgency of the need to perform a regeneration is an estimate of engine on time, before the need to regenerate becomes critical.

22. The system of claim 18, wherein the indication of the urgency of the need to perform a regeneration is a location along a projected route, indicating an estimate of where the need to perform a regeneration will become critical.
